(19) United States
(12) Patent Application Publication
(10) Pub. No.: US 2024/0215021 A1
(43) Pub. Date: Jun. 27, 2024

(54) RADIO COMMUNICATION NODE

(71) Applicant: NTT DOCOMO, INC., Tokyo (JP)

(72) Inventors: Daisuke Kurita, Tokyo (JP); Hiroki Harada, Tokyo (JP)

(73) Assignee: NTT DOCOMO, INC., Tokyo (JP)

(21) Appl. No.: 18/558,095

(22) PCT Filed: May 10, 2021
(86) PCT No.: PCT/JP2021/017710

§ 371 Date: Oct. 30, 2023

(51) Int. Cl. H04W 72/1268; H04W 72/0446; H04W 72/1273

(52) U.S. Cl. CPC H04W 72/1268; H04W 72/0446; H04W 72/1273

(57) ABSTRACT

A radio communication node includes: a control unit that determines a downlink transmission timing in the radio communication node based on a downlink transmission timing in an upper node; and a transmission/reception unit that performs transmission and reception at the determined timing, wherein the control unit determines an uplink transmission timing in the radio communication node based on a specifying method.

### TECHNICAL FIELD

This disclosure relates to a radio communication node that configures radio access and radio backhaul.

### BACKGROUND ART

The 3rd Generation Partnership Project (3GPP) has prepared a specification for Long Term Evolution (LTE), and with the aim of further accelerating in the LTE, a specification for LTE-Advanced (hereinafter referred to as LTE, including LTE-Advanced) is specified. Further, a successor system to LTE which is called 5G New Radio (NR) or Next Generation (NG) has been specified.

For example, in a radio access network (RAN) with NR, integrated access and backhaul (IAB) has been studied which integrates radio access to terminals (user equipment, UE) and radio backhaul between radio communication nodes such as radio base stations (gNBs) (see Non-Patent Literature 1)

In IAB, an IAB node has a mobile termination (MT), which is a function for connection to a parent node (which may be called an IAB donor), and a distributed unit (DU), which is a function for connection to a child node or a UE.

In 3GPP Release 16, half-duplex and time division multiplexing (TDM) are assumed in radio access and radio backhaul. In Release 17 and thereafter, the application of space division multiplexing (SDM) and frequency division multiplexing (FDM) have been studied.

In Non-Patent Literature 1, seven cases are specified regarding the alignment of the transmission timing between a parent node and an IAB node. For example, the following cases are specified as assumptions: alignment of the downlink (DL) transmission timing between an IAB node and an IAB donor (Case #1); alignment of the DL transmission timing and uplink (UL) transmission timing within an IAB node (Case #2); alignment of the DL reception timing and UL reception timing within an IAB node (Case #3); within an IAB node, alignment of the transmission timing of Case #2 is applied in transmission and alignment of the reception timing of Case #3 is applied in reception (Case #4); a combination of alignment of the DL transmission timing of Case #1 and alignment of the UL transmission timing of Case #2 (Case #6); and a combination of alignment of the DL transmission timing of Case #1 and alignment of the UL reception timing of Case #3 (Case #7).

In Case #1, in order to make the DL transmission timing of each node in a DU coincide with each other, it is agreed that the IAB node calculates a propagation delay (T_{propagation_0}) of the path (0) with a parent node by using the formula (TA/2+T_delta) and transmits a transmission timing that is offset.

Here, TA is the value of Timing Advance for determining the UE transmission timing specified in 3GPP Release 15, and T_delta is determined in consideration of the switching time from reception to transmission in a parent node, or the like.

### CITATION LIST

### Non-Patent Literature

Non-Patent Literature 1: 3GPP TR 38.874 V 16.0.0, 3rd Generation Partnership Project; Technical Specification Group Radio Access Network; NR; Study on Integrated Access and Backhaul; (Release 16), 3GPP, December 2018

### SUMMARY OF THE INVENTION

Meanwhile, assuming that an IAB node supports two or more cases from among Case #1 to Case #7, a mechanism is required to appropriately determine a UL transmission timing (which may be called an MT transmission timing) for an IAB node.

Therefore, an object of the present invention is to provide a radio communication node that can appropriately determine an MT transmission timing when one or more alignment methods are supported by an IAB node as a mechanism for defining an MT transmission timing for the IAB node, in integrated access and backhaul (IAB).

A summary of an aspect of the present disclosure is a radio communication node, which includes: a control unit that determines a downlink transmission timing in the radio communication node based on a downlink transmission timing in an upper node; and a transmission/reception unit that performs transmission and reception at the determined timing, in which the control unit determines an uplink transmission timing in the radio communication node based on a specifying method.

A summary of an aspect of the present disclosure is a radio communication method, which includes: a step of determining a downlink transmission timing in a radio communication node based on a downlink transmission timing in an upper node; a step of determining an uplink transmission timing in the radio communication node based on a specifying method; and a step of performing transmission and reception at the determined timing.

### BRIEF DESCRIPTION OF THE DRAWINGS

FIG. 1 is an overall schematic diagram of a radio communication system 10.

FIG. 2 is a diagram illustrating an example of a basic configuration of IAB.

FIG. 3 is a configuration diagram illustrating a functional block of a radio communication node 100A.

FIG. 4 is a configuration diagram illustrating a functional block of a radio communication node 100B.

FIG. 5 is a diagram illustrating an example of a relationship among T_{propagation_0}, TA, and, T_delta.

FIG. 6 is a diagram illustrating an outline of Case #1, Case #6, and Case #7.

FIG. 7 is a diagram in which Case #1, Case #6, and Case #7 are applied.

FIG. 8 is a diagram illustrating an example of ConfiguredGrantConfigInformation.

FIG. 9 is a diagram illustrating an example of a hardware configuration of a CU 50 and radio communication nodes 100A to 100C.

### DESCRIPTION OF EMBODIMENTS

Embodiments will be described below with reference to the drawings. Note that the same or similar reference numerals have been attached to the same functions and configurations, and the descriptions thereof will be omitted as appropriate.

### (1) OVERALL SCHEMATIC CONFIGURATION OF RADIO COMMUNICATION SYSTEM

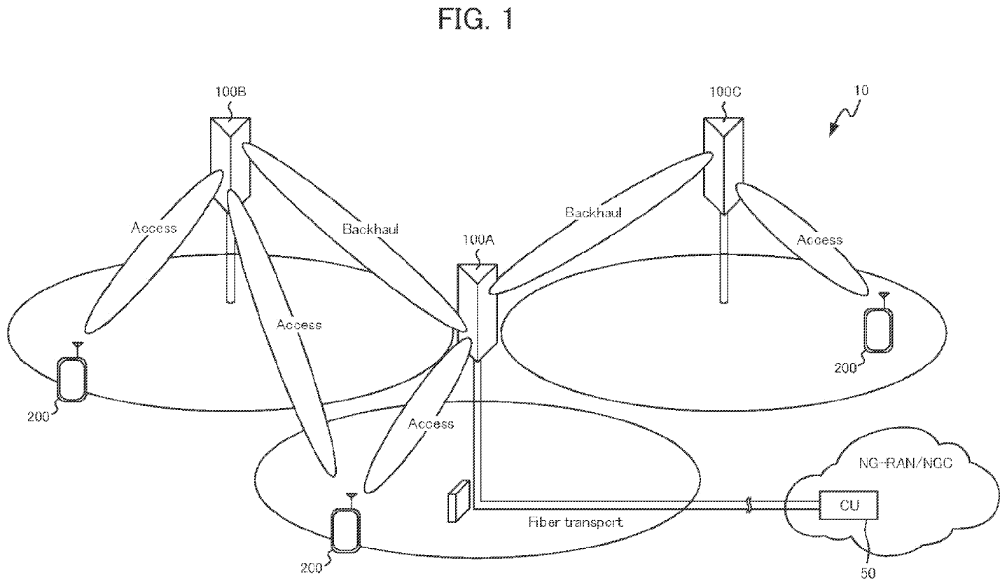

FIG. 1 is an overall schematic diagram of a radio communication system 10 according to an embodiment. The radio communication system 10 is a radio communication system in accordance with 5G New Radio (NR), and is configured of multiple radio communication nodes and terminal.

Specifically, the radio communication system 10 includes radio communication nodes 100A, 100B, and 100C, and terminals 200 (hereinafter, UEs (user equipment) 200).

The radio communication nodes 100A, 100B, and 100C can configure radio access with the UEs 200, and radio backhaul (BH) between the radio communication nodes. Specifically, backhauls (transmission paths) using radio links are configured between the communication node 100A and the communication node 100B, and between the communication node 100A and the communication node 100C.

Abovementioned, a configuration in which radio access to the UEs 200 and radio backhaul between the radio communication nodes are integrated is called integrated access and backhaul (IAB).

IAB reuses existing functions and interfaces defined for radio access. In particular, a mobile termination (MT), a gNB-DU (distributed unit), a gNB-CU (central unit), a user plane function (UPF), an access and mobility management function (AMF), a session management function (SMF), and corresponding interfaces such as NR Uu (between MT and gNB/DU), F1, NG, X2, and N4 are used as a baseline.

The radio communication node 100A is connected to a radio access network with NR (NG-RAN) and a core network (Next Generation Core (NGC) or 5GC) via a wired transmission path such as fiber transport. The NG-RAN/NGC includes a central unit 50 (hereinafter, CU 50), which is a communication node. The NG-RAN and NGC may be simply described as a “network”.

The CU 50 may be configured of any of the UPF, AMF and SMF described above or a combination thereof. Alternatively, the CU 50 may be a gNB-CU as described above.

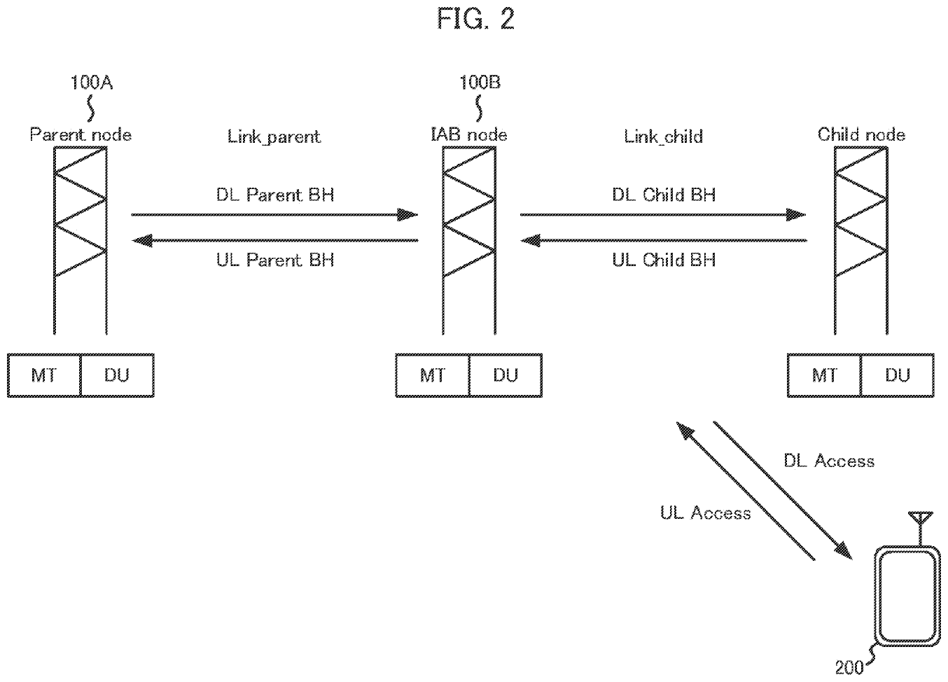

FIG. 2 is a diagram illustrating an example of a basic configuration of IAB. As illustrated in FIG. 2, in the embodiment, the radio communication node 100A constitutes a parent node in IAB, and the radio communication node 100B (and the radio communication node 100C) constitutes an IAB node in IAB. Note that the parent node may be referred to as an IAB donor and may be considered as a kind of IAB node. Further, a grandparent node (not illustrated), which is a parent node of the parent node, may be configured.

A child node in IAB is configured of other radio communication nodes that are not illustrated in FIG. 1. Alternatively, the UE 200 may constitute a child node.

A radio link is configured between the parent node and the IAB node. Specifically, a radio link called Link_parent is configured.

A radio link is configured between the IAB node and the child node. Specifically, a radio link called Link_child is configured.

A radio link that is configured between such radio communication nodes is called a radio backhaul link. The Link_parent includes a DL Parent BH in the downlink (DL) direction and a UL Parent BH in the uplink (UL) direction. The Link_child includes a DL Child BH in the DL direction and a UL Child BH in the UL direction.

That is, in IAB, the direction from the parent node to the child node (including UE 200) is the DL direction, and the direction from the child node to the parent node is the UL direction.

A radio link that is configured between the UE 200 and the IAB node or the parent node is called a radio access link. Specifically, the radio access link includes DL Access in the DL direction and UL Access in the UL direction.

The IAB node has a mobile termination (MT), which is a function for connection to a parent node, and a distributed unit (DU), which is a function for connection to a child node (or the UE 200). The child node may be referred to as a lower node.

Similarly, the parent node has an MT, which is a function for connection to an upper node, and a DU, which is a function for connection to a lower node such as an IAB node. The parent node may have a CU (central unit) instead of an MT.

Further, similar to the IAB node and the parent node, the child node has an MT, which is a function for connection to an upper node such as an IAB node, and a DU, which is a function for connection to a lower node such as the UE 200.

The radio resource used by the DU includes, from the viewpoint of the DU, a DL, a UL, and a flexible time-resource (D/U/F), and the radio resource is classified into any type of hard, soft, or not available (H/S/NA). In addition, “available” or “not available” is also specified in soft (S).

Although CU/DU division is used in the configuration example of IAB illustrated in FIG. 2, IAB is not necessarily limited to such a configuration. For example, in radio backhaul, IAB may be configured by tunneling using a GPRS Tunneling Protocol (GTP)-U/User Datagram Protocol (UDP)/Internet Protocol (IP).

The main advantage of such IAB is that NR cells can be arranged flexibly and densely without increasing the density of the transport network. IAB can be applied to a variety of scenarios, including outdoor small cell placement, indoor, and even support for mobile relay (for example, in buses and on trains).

Further, IAB may support deployment by means of NR-only standalone (SA), as illustrated in FIGS. 1 and 2, or deployment by means of non-standalone (NSA) including other RATs (such as LTEs).

In the embodiment, radio access and radio backhaul operate based on the assumption of half-duplex communication; however, they are not necessarily limited to half-duplex communication, and full-duplex communication is also possible as long as the requirements are satisfied.

In addition, time division multiplexing (TDM), space division multiplexing (SDM), and frequency division multiplexing (FDM) are available as multiplexing schemes.

When the IAB node operates in half-duplex communication, the DL Parent BH is on the receiving (RX) side, the UL Parent BH is on the transmitting (TX) side, the DL Child BH is on the transmitting (TX) side, and the UL Child BH is on the receiving (RX) side. Further, in time division duplex (TDD), the configuration pattern of DL/UL in the IAB node is not limited to only DL-F-UL. For example, other configuration patterns, such as only radio backhaul (BH) or UL-F-DL, may be applied.

In addition, in the embodiment, for example, simultaneous operation of a DU and an MT in the IAB node may be realized using SDM/FDM.

### (2) FUNCTION BLOCK CONFIGURATION OF RADIO COMMUNICATION SYSTEM

Next, a function block configuration of the radio communication node 100A and the radio communication node 100B included in the radio communication system 10 will be described.

### (2.1) Radio Communication Node 100A

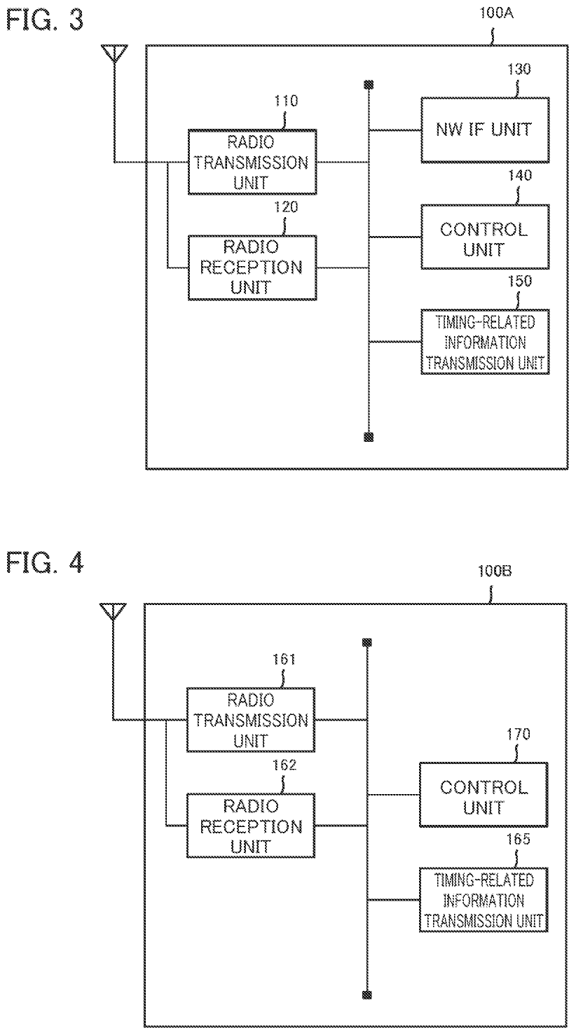

FIG. 3 is a configuration diagram illustrating a functional block of the radio communication node 100A constituting a parent node. As illustrated in FIG. 3, the radio communication node 100A includes a radio transmission unit 110, a radio reception unit 120, an NW IF unit 130, a control unit 140, and a timing-related information transmission unit 150.

The radio transmission unit 110 transmits radio signals according to the 5G specification. In addition, the radio reception unit 120 receives radio signals according to the 5G specification. In the embodiment, the radio transmission unit 110 and the radio reception unit 120 perform radio communication with the radio communication node 100B constituting an IAB node. The radio communication node 100A has MT and DU functions, and the radio transmission unit 110 and the radio reception unit 120 transmit and receive radio signals corresponding to MT/DU.

In the embodiment, the radio reception unit 120 may include a reception unit that receives capability information (for example, information such as whether each of Case #1, Case #2, Case #3, Case #6, and Case #7 is supported or not) regarding the capability of timing alignment, from a lower node such as the radio communication node 100B.

The NW IF unit 130 provides a communication interface that realizes connection with the NGC side or the like. For example, the NW IF unit 130 may include interfaces such as X2, Xn, N2, N3, or the like.

The control unit 140 performs alignment of each functional block included in the radio communication node 100A. For example, the control unit 140 may perform alignment to align the DL transmission timing in the IAB node (for example, DU transmission timing) with the DL transmission timing in an upper node. The control unit 140 may perform alignment to align the UL transmission timing (for example, MT transmission timing) and the DL transmission timing (for example, DU transmission timing). The control unit 140 may perform alignment to align the DL reception timing (for example, MT reception timing) and the UL reception timing (for example, DU reception timing).

For example, the alignment to align the DL transmission timing in the IAB node with the DL transmission timing in an upper node may correspond to Case #1 specified in 3GPP TR 38.874. The alignment to align the UL transmission timing and the DL transmission timing in the IAB node may correspond to Case #2 specified in 3GPP TR 38.874. Further, the alignment to align the DL reception timing and the UL reception timing in the IAB node may correspond to Case #3 specified in 3GPP TR 38.874.

The timing alignment in the IAB node may include alignment to align the UL transmission timing and the DL transmission timing in addition to the alignment to align the DL transmission timing in the IAB node with the DL transmission timing in an upper node. That is, the control unit 140 may support Case #6, which is a combination of the alignment of Case #1 and the alignment of Case #2.

The timing alignment in the IAB node may include alignment to align the DL reception timing and the UL reception timing in addition to the alignment to align the DL transmission timing in the IAB node with the DL transmission timing in an upper node. That is, the control unit 140 may support Case #7, which is a combination of the alignment of Case #1 and the alignment of Case #3.

Here, the control unit 140 can acquire a propagation delay between the radio communication node 100A (parent node) and the radio communication node 100B (lower node).

Specifically, the control unit 140 calculates the propagation delay of the path (0) between the parent node and the lower node on the basis of Equation 1.

$${T}_{propagation \_ 0} = ( TA / 2 + T\_delta ) \qquad ( Equation 1 )$$

TA is the value of Timing Advance (TA) for determining the UE transmission timing as specified in 3GPP Release 15. Here, TA may be referred to as timing information. T_delta may be determined in consideration of the switching time from reception to transmission of a parent node, or the like.

In addition to the alignment to align the DL transmission timing in the IAB node with the DL transmission timing in an upper node, the control unit 140 may perform alignment to align the DL transmission timing and the UL transmission timing (Case #6). In such a case, the control unit 140 may acquire a propagation delay between the radio communication node 100A (parent node) and the radio communication node 100B (lower node), which is used to determine the DL transmission timing, or a propagation delay between the radio communication node 100A and the radio communication node 100B, which is used to determine the UL transmission timing in the radio communication node 100B.

The propagation delay may mean T_{propagation_0}, T1, or may mean Tₚᵣₒₚ₁, T2, Tₚₒᵣₚ₂, TA/2, or TA. The propagation delay may also be referred to as transmission time, delay time, or simply delay, or it may be referred to by any other name as long as it indicates the time required for the DL or UL transmission between radio communication nodes constituting IAB.

T1 is the difference between the MT Rx timing and DU Tx timing of the parent node. In addition to T1, the parent node notifies the IAB node of “the number of offset symbols”. “The number of offset symbols” may include 0 (for example, any of 0, 1, 2, and 3 is selected). If 0, timing alignment may be performed at the slot level. In addition, the presence or absence of a T1/offset notification may be used to determine the timing mode.

T2 is “1 symbol length”×“the number of offset symbols”−(the difference between MT Rx timing and DU Tx timing). The timing mode may be determined by the presence or absence of a T2 notification. In addition, “the number of offset symbols” does not need to be indicated to the IAB node (the IAB node may be notified separately).

Tₚᵣₒₚ₁ is a propagation delay between the parent node and the grandparent node, and Tₚᵣₒₚ₂ is a propagation delay between the parent node and the IAB node (Tₚᵣₒₚ₂).

In addition to the alignment to align the DL transmission timing in the IAB node with the DL transmission timing in an upper node, the control unit 140 may perform alignment to align the DL reception timing and the UL reception timing (Case #7). In such a case, the control unit 140 may determine an alignment value for the reception timing based on timing information used to determine the UL transmission timing, specifically, based on TA, or may determine an offset value from the timing information (TA).

Here, an alignment value for the reception timing based on TA may be the value of TA according to a TA command in a Random Access Response (RAR) to which information indicating positive (+) or negative (−) has been added (for example, 1 bit). The alignment value may be only information indicating negative, or may be another value associated with being negative.

Alternatively, the value of TA (N_{TA}) may be an expanded value. Specifically, in 3GPP Release-15, N_{TA} may take values of 0, 1, 2, . . . , 3846; however, an alignment value for the reception timing based on TA may indicate a negative value by subtracting from 3846, for example, using a value of 3847 to 4095. Note that a value of 3847 or greater may be treated as an implicit negative value without subtraction.

In addition, an offset value from the timing information (TA) may indicate an offset (time) from the value of TA specified in 3GPP Release 15, or from the value of TA corresponding to Case #1, Case #6 and/or Case #7 described above. The offset value may be a value based on TA, or may be a value that is not based on TA as long as the offset time can be determined.

In principle, Timing Advance (TA) is positive in the direction going back in time and negative in the direction going forward in time. For this reason, for example, assuming that the timing information, alignment value, or offset value is positive or not negative may mean, in the embodiment, that transmission is performed in advance temporally, rather than by shifting backward temporally. In contrast, for example, assuming that the timing information, alignment value, or offset value is negative or not positive may mean, in the embodiment, that transmission is not performed in advance temporally, but is performed by shifting backward temporally.

In addition, an offset value from the timing information (TA) may indicate TA specified in 3GPP Release 15, or an offset (time) from the value of TA. The offset value may be a value based on TA, or may be a value that is not based on TA as long as the offset time can be determined.

The timing-related information transmission unit 150 transmits information relating to a DL or UL transmission timing, or a DL or UL reception timing (hereinafter, timing-related information), to a lower node. Specifically, the timing-related information transmission unit 150 may transmit, to the IAB node and/or the child node, information (TA, T1, T2, etc.) relating to a DL or UL transmission timing, or a DL or UL reception timing, as the timing-related information. The timing-related information may include the number of offset symbols, a symbol length, or the like. The timing-related information transmission unit 150 may transmit, to a lower node, an alignment value for the reception timing based on TA, or an offset value from TA, as the timing-related information.

The timing information (TA) can be transmitted using a TA command in a Random Access Response (RAR), or using a Medium Access Control-Control Element (MAC-CE). Similarly, the timing-related information may be transmitted using a MAC-CE, or using an appropriate channel or signaling of a higher layer (such as radio resource control layer (RRC)).

The channels include control channels and data channels. The control channels include a PDCCH (physical downlink control channel), a PUCCH (physical uplink control channel), a PRACH (physical random access channel), and a PBCH (physical broadcast channel).

The data channels include a PDSCH (physical downlink shared channel), and a PUSCH (physical uplink shared channel).

The reference signals include demodulation reference signals (DMRS), sounding reference signals (SRS), phase tracking reference signals (PTRS), and channel state information-reference signals (CSI-RS), and the signals include the channels and the reference signals. Further, the data may mean the data transmitted via the data channels.

UCI is control information that is symmetric to downlink control information (DCI), and UCI is transmitted via a PUCCH or a PUSCH. UCI may include a scheduling request (SR), a hybrid automatic repeat request (HARQ) ACK/NACK, a channel quality indicator (CQI), and the like.

### (2.2) Radio Communication Node 100B

FIG. 4 is a configuration diagram illustrating a functional block of the radio communication node 100B constituting an IAB node. As illustrated in FIG. 4, the radio communication node 100B includes a radio transmission unit 161, a radio reception unit 162, a timing-related information transmission unit 165, and a control unit 170.

The radio transmission unit 161 transmits radio signals according to the 5G specification. In addition, the radio reception unit 162 transmits radio signals according to the 5G specification. In the embodiment, the radio transmission unit 161 and the radio reception unit 162 include a transmission/reception unit that performs transmission and reception at a timing determined by the control unit 170.

In the embodiment, the radio transmission unit 161 may include a transmission unit that transmits capability information regarding the capability of timing alignment, to an upper node or a lower node, etc.

The timing-related information transmission unit 165 receives information relating to a DL or UL transmission timing, or a DL or UL reception timing (timing-related information), from an upper node. The details of the timing-related information have been described as above.

The control unit 170 controls each functional block included in the parent node 100B. In the embodiment, the control unit 170 constitutes a control unit that determines a downlink transmission timing in a radio communication node (here, the radio communication node 100B) based on a downlink transmission timing in an upper node (for example, the radio communication node 100A). The control unit 170 determines an uplink transmission timing in the radio communication node 100B based on a specifying method.

For example, the control unit 170 may perform alignment to align the DL transmission timing in the IAB node (for example, DU transmission timing) with the DL transmission timing in the upper node (for example, the radio communication node 100A constituting the parent node). The control unit 170 may perform alignment to align the UL transmission timing (for example, MT transmission timing) and the DL transmission timing (for example, DU transmission timing). The control unit 170 may perform alignment to align the DL reception timing (for example, MT reception timing) and the UL reception timing (for example, DU reception timing).

For example, the alignment to align the DL transmission timing in the IAB node (here, the radio communication node 100B) with the DL transmission timing in the upper node (for example, the radio communication node 100A) may correspond to Case #1 specified in 3GPP TR 38.874. The alignment to align the UL transmission timing and the DL transmission timing in the IAB node (here, the radio communication node 100B) may correspond to Case #2 specified in 3GPP TR 38.874. The alignment to align the DL reception timing and the UL reception timing in the upper node (for example, radio communication node 100A) may correspond to Case #3 specified in 3GPP TR 38.874. In such a case, the UL transmission timing in the IAB node (here, the radio communication node 100B) is adjusted according to the UL reception timing in the upper node (for example, the radio communication node 100A).

The timing alignment in the IAB node may include alignment to align the UL transmission timing and the DL transmission timing in addition to the alignment to align the DL transmission timing with the DL transmission timing in an upper node. That is, the control unit 170 may support Case #6, which is a combination of the alignment of Case #1 and the alignment of Case #2.

The timing alignment in the IAB node may include alignment to align the DL reception timing and the UL reception timing in addition to the alignment to align the DL transmission timing with the DL transmission timing in an upper node. That is, the control unit 170 may support Case #7, which is a combination of the alignment of Case #1 and the alignment of Case #3.

As described above, Case #6 and Case #7 are considered in addition to Case #1 for which there are no particular limiting conditions, as a method for aligning the UL transmission timing in the IAB node (here, the radio communication node 100B).

As an example, the control unit 170 may align the DL transmission timing in the upper node (for example, the radio communication node 100A) and the DL transmission timing in the radio communication node 100B on the basis of the switching time from UL reception to DL transmission, specifically, on the basis of T_delta.

In such a case, T_delta may be half of the value of the switching time from reception to transmission in the upper node (parent node). That is, the control unit 170 may align the DL transmission timing by considering the switching time from reception to transmission in the parent node.

When T2 is included in the received timing-related information, the control unit 170 may configure the timing in which T2+(TA+T_dalta) is offset from the reception timing (MT Rx timing), as the UL transmission timing (MT Tx timing).

When T1 is included in the received timing-related information, the control unit 170 may configure the timing in which (TA+T_dalta)−T1 is offset from the reception timing (MT Rx timing), as the UL transmission timing (MT Tx timing).

When T1 is included in the received timing-related information, the control unit 170 may configure the timing in which “the symbol length”×“the number of offset symbols”−T1+(TA+T_dalta) is offset from the reception timing (MT Rx timing), as the UL transmission timing (MT Tx timing).

### (3) BACKGROUND ART

In the following description, as background art, the contents of 3GPP specifications will be briefly described. The following seven cases are specified in 3GPP TR 38.874 (for example, V16.0.0) in order to make the DL transmission timing or UL transmission timing between radio communication nodes constituting IAB coincide with each other.
(Case #1): Alignment of DL transmission timing between IAB node and IAB donor
(Case #2): Alignment of DL and UL transmission timing within IAB node
(Case #3): Alignment of DL and UL reception timing within IAB node
(Case #4): Transmission performed according to Case #2 and reception performed according to Case #3 within IAB node
(Case #5): In different time slots, Case #1 is applied to access link timing and Case #4 is applied to backhaul link timing within IAB node
(Case #6): Alignment of DL transmission timing for Case #1+alignment of UL transmission timing for Case #2
(Case #7): Alignment of DL transmission timing for Case #1+alignment of UL reception timing for Case #3

In 3GPP Release 16, as described above, in order to align the DL transmission timing (DU transmission timing) among radio communication nodes constituting IAB, an IAB node calculates a propagation delay (T_{propagation_0}) of the path (0) with a parent node by using the formula (TA/2+T_delta) and transmits a transmission timing that is offset.

Here, TA is the value of Timing Advance for determining the UE transmission timing specified in 3GPP Release 15, and T_delta is determined in consideration of the switching time from reception to transmission of a parent node, or the like.

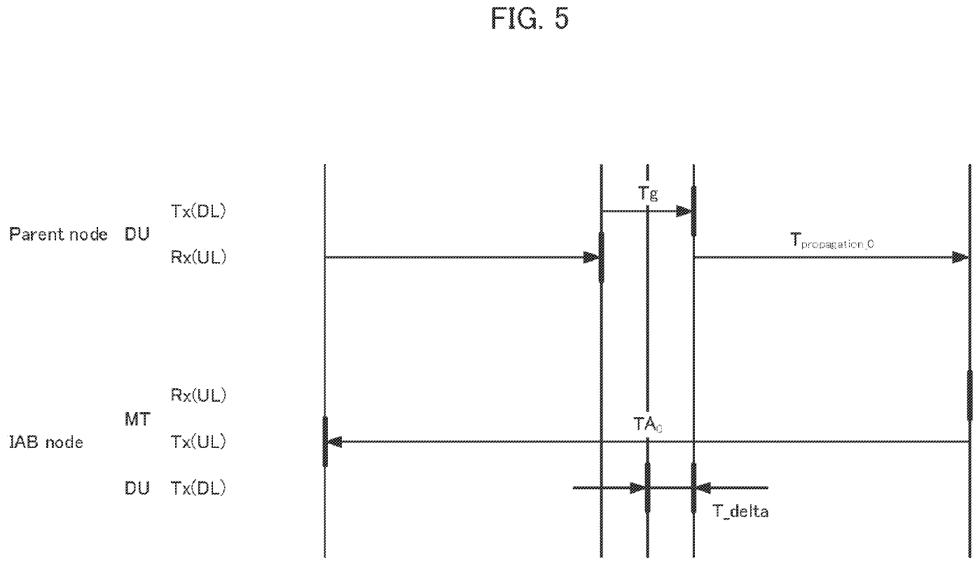

FIG. 5 is a diagram illustrating an example of a relationship among a propagation delay T_{propagation_0}, TA, and T_delta. As illustrated in FIG. 5, T_{propagation_0} is a value obtained by dividing TA₀ between the parent node and the IAB node by 2 and adding T_delta thereto. T_delta may correspond to a value obtained by dividing a gap (Tg) associated with the switching time from UL reception to DL transmission in the parent node by 2.

### (4) OPERATION EXAMPLE

Next, an operation of the radio communication system 10 will be described. Specifically, a description will be given regarding a case in which the radio communication nodes constituting IAB support Case #6 and Case #7 in addition to Case #1.

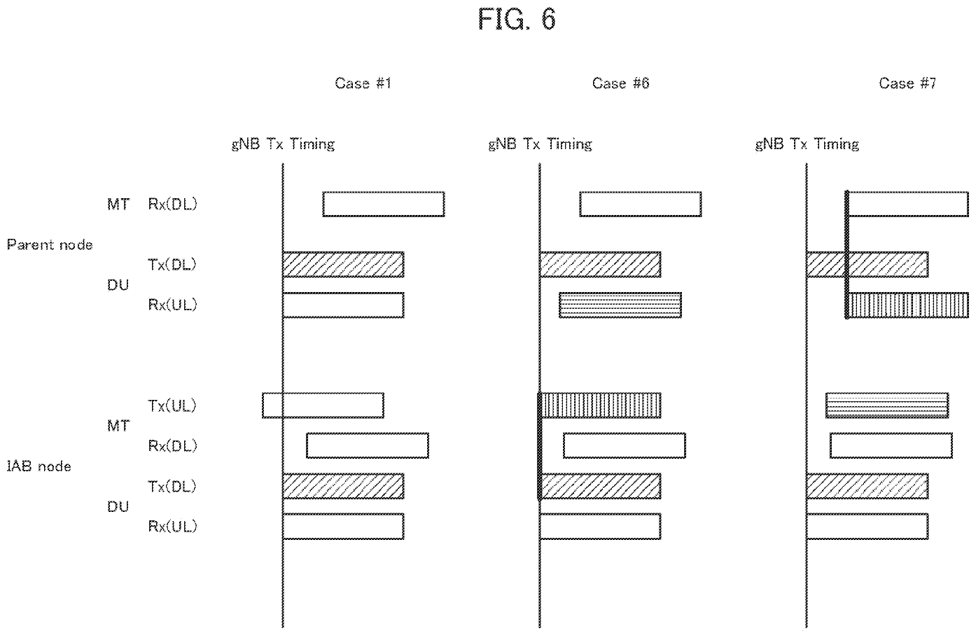

As illustrated in the left column of FIG. 6, in Case #1, the DL transmission timing (DU transmission timing) in an IAB node is adjusted to align with the DL transmission timing (DU transmission timing) in the parent node. As illustrated in the middle column of FIG. 6, in Case #6, the UL transmission timing (MT transmission timing) in the IAB node is adjusted to align with the DL transmission timing (DU transmission timing). As illustrated in the right column of FIG. 6, in Case #7, under the assumption that the UL reception timing (DU reception timing) in the parent node is adjusted to align with the DL reception timing (MT reception timing), the UL transmission timing (MT transmission timing) in the IAB node is adjusted to align with the UL reception timing (DU reception timing) in the parent node. Note that, in the embodiment, the DU reception timing and MT reception timing in the IAB node are not particularly limited, and these may or may not be aligned with each other.

In the case where Case #6 is supported, the simultaneous transmission of DU Tx in the parent node and DU Tx in the IAB node (Case #1) needs to be realized in addition to the simultaneous transmission of MT Tx and DU Tx in the IAB node (Case #2). Similarly, in the case where Case #7 is supported, the simultaneous transmission of DU Tx in the parent node and DU Tx in the IAB node (Case #1) needs to be realized in addition to the simultaneous reception of MT Rx and DU Rx in the parent node (Case #3). For this reason, not only the propagation delay between the parent node and the IAB node (Tₚᵣₒₚ₂), but also the propagation delay between the parent node and the grandparent node (Tₚᵣₒₚ₁) may be considered.

Under such an assumption, a specifying method for determining the UL transmission timing (MT transmission timing) in the IAB node (for example, the radio communication node 100B) will be described. The following options are considered as the specifying methods.

### (4.1) Option 1

In Option 1, the specifying method includes a method for configuring an uplink transmission timing (MT transmission timing) in the radio communication node by means of an upper node. The upper node may be a parent node (for example, a radio communication node 100A), or a CU 50.

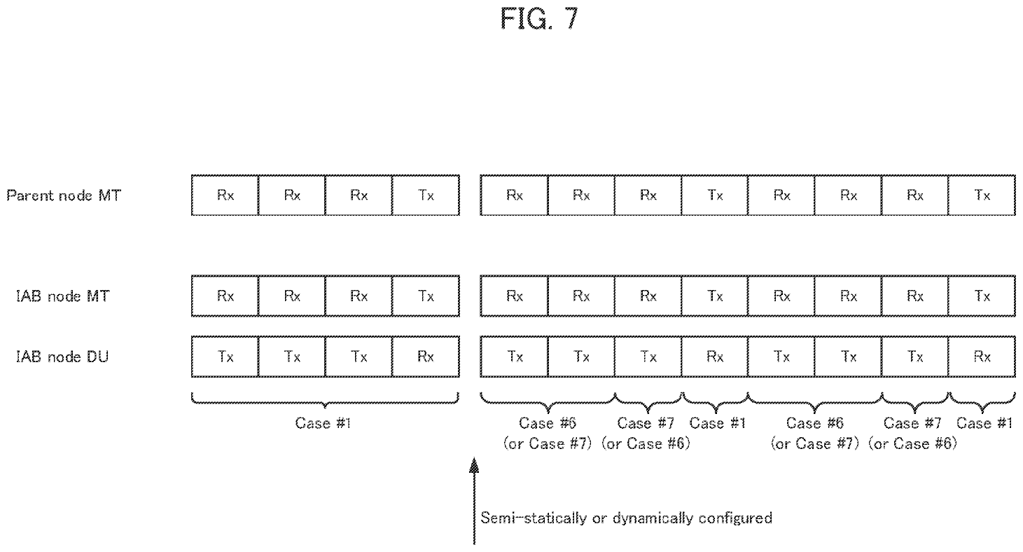

For example, as illustrated in FIG. 7, when Case #1 is applied to the IAB node (for example, the radio communication node 100B), the upper node configures which of Case #1, Case #6, and Case #7 is to be applied, as the UL transmission timing (MT transmission timing) in the IAB node. For example, the IAB node may receive, from the upper node, an information element that explicitly indicates which of Case #1, Case #6, and Case #7 is to be applied. Such an information element may be a type of timing-related information described above.

Firstly, which of Case #1, Case #6, and Case #7 is to be applied may be configured in “semi-static” (hereinafter, Option 1-1). An information element that configures any one of Case #1, Case #6, and Case #7 in “semi-static” may be included in an RRC message, or in the message of an interface (F1-AP) between gNB-CU and gNB-DU. The information element may be referred to as the timing mode. The timing mode may be configured for each time resource (for example, a slot or symbol).

Case #1 may be considered to be one of the timing modes. In such a case, all the timing modes that is applied in each time resource may be configured. Alternatively, Case #1 may be considered not to be one of the timing modes. In such a case, Case #1 may be applied to a time resource for which the timing mode is not configured.

Secondly, which of Case #1, Case #6, and Case #7 is to be applied may be configured in “dynamic” (hereinafter, Option 1-2).

For example, an information element that configures any one of Case #1, Case #6, and Case #7 in “dynamic” may be included in the DCI that is used by the parent node for scheduling MT Tx in the IAB node.

The information element that configures any one of Case #1, Case #6, and Case #7 may be an existing field (for example, HARQ) included in an existing DCI (for example, DCI format 0_0/0_1/0_2, DCI format 1_0/1_1/1_2), and which of Case #1, Case #6, and Case #7 is to be applied may be implicitly specified by rereading the existing field.

Alternatively, an information element that configures any one of Case #1, Case #6, and Case #7 may be a new field included in a newly defined DCI, and which of Case #1, Case #6, and Case #7 is to be applied may be explicitly specified by the new field.

Alternatively, the information element that configures any one of Case #1, Case #6, and Case #7 in “dynamic” may be defined by a DCI that includes an information element regarding the transmission timing.

The information element that configures any one of Case #1, Case #6, and Case #7 may be included in an extended existing DCI by extending an existing DCI (for example, DCI format 2_5). The existing DCI may include an information element specifying a radio resource used by the IAB-DU. The radio resource used by the IAB-DU may include, from the DU perspective, a DL, an UL, and a flexible time-resource (D/U/F), which may be classified into any type of hard, soft, or not available (H/S/NA). In addition, “available” or “not available” (NA) is also specified in soft (S). The existing DCI may include an information element that configures any one of Case #1, Case #6, and Case #7 in addition to an information element that specifies a radio resource used by the DU.

Alternatively, the information element that configures any one of Case #1, Case #6, and Case #7 may be included in a newly defined DCI.

Alternatively, the information element that configures any one of Case #1, Case #6, and Case #7 may be included in a TA command.

Alternatively, the IAB node may be implicitly notified depending on whether the timing-related information includes T_delta. The IAB node may be implicitly notified depending on whether the timing-related information includes an alignment value or an offset value. The IAB node may determine which of Case #1, Case #6, and Case #7 is to be configured, based on the T_delta, the alignment value, or the offset value. The timing-related information may include an information element that specifies the timing mode.

Thirdly, which of Case #1, Case #6, and Case #7 is to be applied may be configured (specified) in “semi-persistent” (hereinafter, Option 1-3).

An information element that configures any one of Case #1, Case #6, and Case #7 in “semi-persistent” may be included in a MAC CE message, or may be included in the DCI. The information element that configures any one of Case #1, Case #6, and Case #7 in “semi-persistent” may include an information element that specifies the start of Case #6 or Case #7, or an information that specifies the end of Case #6 or Case #7. Case #1 may be applied during a period when Case #6 or Case #7 is not configured. The period when Case #6 or Case #7 is applied may be managed by a timer triggered by the start of Case #6 or Case #7. When the timer is introduced, no information element specifying the end of Case #6 or Case #7 may be defined. When the timer has expired, Case #1 may be applied.

Fourthly, which of Case #1, Case #6, and Case #7 is to be applied may be configured by a higher layer (hereinafter, Option 1-4).

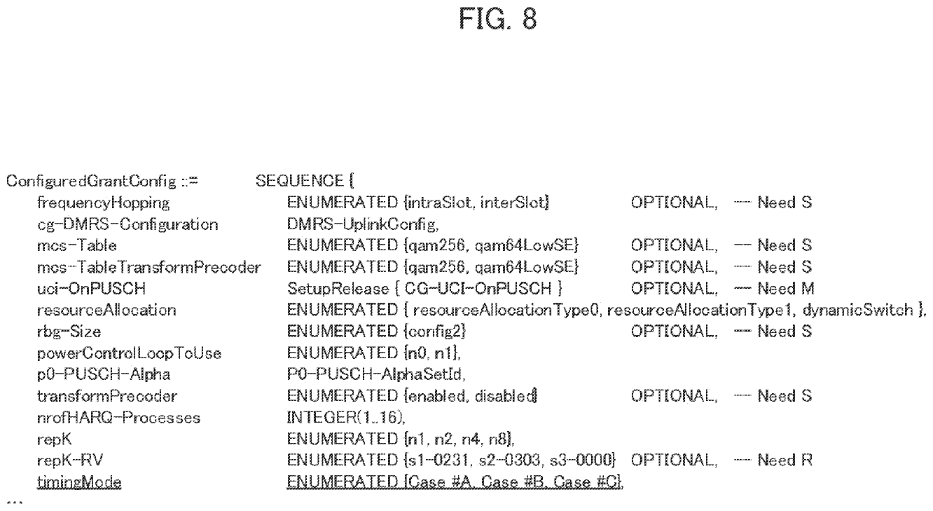

An information element indicating which of Case #1, Case #6, and Case #7 is to be applied may be included in an RRC message. The RRC message may be a message that includes an information element indicating which of Case #1, Case #6, and Case #7 is to be applied in addition to an information element configuring frequency and time resources for RL resources (configured grant PUSCH, SRS, PUSCH, or the like). The information element may be referred to as the timingMode. For example, as illustrated in FIG. 8, the RRC message may be ConfiguredGrantConfigInformation including the timingMode.

### (4.2) Option 2

In Option 2, the specifying method includes a method for specifying an uplink transmission timing (MT transmission timing) in a radio communication node by means of the radio communication node.

For example, the IAB node may notify the upper node of an information element (for example, the timing mode) indicating which of Case #1, Case #6, and Case #7 the IAB node requests to be applied, according to the MT/DU transmission state. The information element may be included in UCI, may be included in a MAC CE message, may be included in an RRC message, or may be included in an F1-AP message. For example, the IAB node may request the upper node for the timing mode along with a scheduling request. The upper node may be a parent node (for example, the radio communication node 100A) or the CU 50.

In such a case, the IAB node may apply the timing mode for which a request has been made to the upper node, on the assumption that the timing mode for which a request has been made to the upper node is configured. Alternatively, when the timing mode for which a request has been made to the upper node is configured by the upper node, the IAB node may apply the timing mode configured by the upper node. The configuration of the timing mode by the upper node may be performed in the same manner as Option 1.

### (4.3) Option 3

In Option 3, the specifying method includes a method for determining an uplink transmission timing (MT transmission timing) in a radio communication node based on a predetermined rule. The predetermined rule may be defined by the configuration details for simultaneous operation of an IAB-DU and an IAB-MT.

For example, the predetermined rule may be defined by radio resources (at least one radio resource in either the time direction, frequency direction, or space direction) used by an IAB-DU. The predetermined rule may be defined by H/S/NA specified in “semi-static”, or IA/INA specified in “dynamic” (Option 3-1).

Alternatively, the predetermined rule may be defined by the configuration of IAB-MT and IAB-DU TDD patterns. The IAB-MT and IAB-DU TDD patterns may be configured by tdd-UL-DL-ConfigDedicated-IAB-MT (Option 3-2).

Alternatively, the predetermined rule may be defined by the configuration of the timing mode described above. The timing mode may be configured by at least one of Options 1 and 2 (Option 3-3).

The IAB node may determine the MT transmission timing based on at least one of Options 3-1 to Option 3-3.

For example, the IAB node may apply the MT transmission timing of Case #6 when the first TDD pattern is configured and the timing mode of Case #6 is configured. Similarly, the IAB node may apply the MT transmission timing of Case #7 when the second TDD pattern is configured and the timing mode of Case #7 is configured. The second TDD pattern may be the same as the first TDD pattern or different from the first TDD pattern.

Alternatively, when hard or soft IA is configured as a radio resource to be used by an IAB-DU, the IAB node may determine the MT transmission timing to coincide with the transmission timing of the IAB-DU (Case #6), on the assumption that both the transmission of the IAB-DU and the transmission of the IAB-MT are performed, in the radio resource where the hard or soft IA is configured. Meanwhile, when NA or soft INA is configured as a radio resource to be used by the IAB-DU, the IAB node may determine the MT transmission timing (Case #1), on the assumption that the transmission of the IAB-MT is performed without performing the transmission of the IAB-DU, in the radio resource where the NA or soft INA is configured.

### (4.4) Option 4

In Option 4, the specifying method includes a method for making a determination based on capability information regarding the capability of timing alignment. The capability information regarding the capability of timing alignment may include an information element that implicitly or explicitly indicates whether the IAB node corresponds to at least one of Case #6 and Case #7.

Firstly, the information element that implicitly indicates whether the IAB node corresponds to at least one of Case #6 and Case #7 may be an information element described below.

For example, the information element that implicitly indicates whether the IAB node corresponds to at least one of Case #6 and Case #7 may be a combination of an information element that indicates whether the IAB node corresponds to TDM of MT-Tx and DU-Tx (that is, simultaneous transmission of MT and DU) and an information element that indicates whether the IAB node corresponds to TDM of MT-Tx and DU-Rx and/or TDM of MT-Rx and DU-Tx. For example, the parent node may determine that the IAB node corresponds to Case #6 when receiving a report that the IAB node corresponds to TDM of MT-Tx and DU-Rx and/or TDM of MT-Rx and DU-Tx in addition to receiving a report that the IAB node corresponds to TDM of MT-Tx and DU-Tx.

For example, the information element that implicitly indicates whether the IAB node corresponds to at least one of Case #6 and Case #7 may be a combination of an information element that indicates whether the IAB node corresponds to TDM of MT-Rx and DU-Rx (that is, a simultaneous reception of MT and DU) and an information element that indicates whether the IAB node corresponds to TDM of MT-Tx and DU-Rx and/or TDM of MT-Rx and DU-Tx. For example, the parent node may determine that the IAB node corresponds to Case #7 when receiving a report that the IAB node corresponds to TDM of MT-Tx and DU-Rx and/or TDM of MT-Rx and DU-Tx in addition to receiving a report that the IAB node corresponds to TDM of MT-Rx and DU-Rx.

Secondly, the information element that explicitly indicates whether the IAB node corresponds to at least one of Case #6 and Case #7 may be an information element described below.

For example, the information element that explicitly indicates whether the IAB node corresponds to at least one of Case #6 and Case #7 may include an information element that indicates whether the IAB node corresponds to each of Case #6 and Case #7.

For example, the information element that explicitly indicates whether the IAB node corresponds to at least one of Case #6 and Case #7 may include an information element that indicates whether the IAB node corresponds to each TA of Case #6 and Case #7.

For example, the information element that explicitly indicates whether the IAB node corresponds to at least one of Case #6 and Case #7 may include an information element that indicates whether the IAB node corresponds to each of Case #6 and Case #7 for each frequency range (for example, FR1, FR2 and the like).

For example, the information element that explicitly indicates whether the IAB node corresponds to at least one of Case #6 and Case #7 may include an information element that indicates whether the IAB node corresponds to each of Case #6 and Case #7 for each frequency band.

For example, the information element that explicitly indicates whether the IAB node corresponds to at least one of Case #6 and Case #7 may include an information element that indicates whether the IAB node corresponds to each of Case #6 and Case #7 for each frequency combination.

### (5) ACTION AND EFFECT

In the embodiment, the IAB node (for example, the radio communication node 100B) determines a downlink transmission timing (DU transmission timing) in the IAB node, based on a downlink transmission timing in an upper node (for example, the radio communication node 100A). Under such an assumption, the IAB node determines an uplink transmission timing (MT transmission timing) in the IAB node, based on the specifying method. According to such a configuration, the MT transmission timing can be appropriately determined when the IAB node can support one or more alignment methods among Case #1, Case #6, and Case #7.

In the embodiment, the specifying method may include a method for configuring an uplink transmission timing (MT transmission timing) in the IAB node by means of an upper node. According to such a configuration, the MT transmission timing can be appropriately determined in the IAB node with appropriately reflecting the state of the upper node.

In the embodiment, the specifying method may include a method for specifying an uplink transmission timing (MT transmission timing) in the IAB node by means of the IAB node. According to such a configuration, the MT transmission timing can be appropriately determined in the IAB node with appropriately reflecting the state of the IAB node.

In the embodiment, the specifying method may include a method for determining an uplink transmission timing (MT transmission timing) in a radio communication node based on a predetermined rule. According to such a configuration, the MT transmission timing can be appropriately determined in the IAB node with reflecting the design philosophy of the radio communication system 10.

In the embodiment, the IAB node transmits capability information regarding the capability of timing alignment, to an upper node. According to such a configuration, the upper node can appropriately configure an alignment method for the MT transmission timing.

### (6) APPENDIX

A description will be given below regarding an example in which Over-the-Air (OTA) synchronization of the above-described Case #6 (a combination of Case #1 and Case #2) or of the above-described Case #7 (a combination of Case #1 and Case #3) is realized.

### (6.1) Case #6

In the timing alignment of Case #6, the following method may be used as a method to determine the transmission timing of the IAB-MT using the transmission timing of the IAB-DU.
Align the transmission timing of the IAB-MT with the transmission timing of the IAB-DU
The IAB-MT derives the transmission timing using a TA (Case #1) and T_delta in the same way as the IAB-DU
The transmission timing of the IAB-MT is in accordance with a TA instruction (Case #6)

When a method is used to align the transmission timing of the IAB-MT with that of the IAB-DU, the transmission timing of the IAB-DU may be derived from a TA (Case #1) and T_delta, or may be derived using GSNN or the like.

When a method is used in which the transmission timing of the IAB-MT is in accordance with a TA instruction (Case #6), the parent node may notify the IAB-node of a TA (Case #6) in conjunction with a TA (Case #1). Note that the IAB-node may determine the timing mode (Case #1/#2/#3/#6/#7 or the like) depending on whether a TA (Case #6) has been notified.

### (6.2) Case #7

In the timing alignment of Case #7, the following method may be used as a method to determine a transmission timing of the IAB-MT using a transmission timing of the IAB-DU. In the timing alignment of Case #7, the transmission timing of the IAB-MT may be determined using the transmission timing of the IAB-DU at a slot level (slot based timing alignment).

Specifically, the IAB-MT may determine the MT transmission timing using T1 as described below (slot based timing alignment).
Configure timing which offsets (TA+T_delta)−T1 from MT Rx timing
Configure timing which offsets (TA+T_delta)/2−T1 from DU Tx timing derived using GNSS or the like

Here, T1 is the difference between the MT Rx timing and DU Tx timing of the parent node. Note that the IAB node may determine the timing mode depending on whether T1 has been notified (when T1 is notified, the IAB node determines the timing mode as Case #7).

In addition, the transmission timing of the IAB-MT may be in accordance with a TA (Case #7) instruction. The parent node notifies the IAB node of a TA (Case #7) in conjunction with a TA (Case #1). Note that the timing mode may be determined depending on whether a TA (Case #7) has been notified.

### (6.3) Case #7

In the timing alignment of Case #7, the following method may be used as a method to determine a transmission timing of the IAB-MT using a transmission timing of the IAB-DU. In the timing alignment of Case #7, the transmission timing of the IAB-MT may be determined using the transmission timing of the IAB-DU at a slot level (slot based timing alignment).

Specifically, the IAB-MT may determine the MT transmission timing using T2 as described below.
Configure timing which offsets T2+(TA+T_delta) from MT Rx timing
Configure timing which offsets T2+(TA+T_delta)/2 from DU Tx timing derived using GNSS or the like

Here, T2 is “1 symbol length”×“the number of offset symbols”−(the difference between MT Rx timing and DU Tx timing). Note that the IAB node may determine the timing mode depending on whether T2 has been notified (when T2 is notified, the IAB node determines the timing mode as Case #7). In addition, “the number of offset symbols” does not need to be indicated to the IAB node (the IAB node may be notified separately).

### (6.4) Case #7

In the timing alignment of Case #7, the following method may be used as a method to determine a transmission timing of the IAB-MT using a transmission timing of the IAB-DU. In the timing alignment of Case #7, the transmission timing of the IAB-MT may be determined using the transmission timing of the IAB-DU at a symbol level (symbol based timing alignment).

Specifically, the IAB-MT may determine the MT transmission timing using T1 as described below.
Configure timing which offsets “symbol length”×“number of symbols”−T1+(TA+T_delta) from MT Rx timing
Configure timing which offsets “symbol length”×“number of symbols”−T1+(TA+T_delta)/2 from DU Tx timing derived using GNSS or the like

Here, T1 is the difference between the MT Rx timing and DU Tx timing of the parent node. In addition to T1, the parent node notifies the IAB node of the “number of offset symbols”. “The number of offset symbols” may include 0 (for example, any of 0, 1, 2, and 3 is selected). If 0, the timing alignment may be performed at the slot level. Note that the IAB node may determine the timing mode depending on whether a T1/offset has been notified (when a T1/offset is notified, the IAB node determines the timing mode as Case #7).

In addition, the transmission timing of the IAB-MT may be performed in accordance with a TA (Case #7) instruction. The parent node notifies the IAB node of a TA (Case #7) in conjunction with a TA (Case #1). Note that the timing mode may be determined depending on whether a TA (Case #7) has been notified.

### (7) OTHER EMBODIMENTS

The contents of the present invention have been described in accordance with the examples as above; however, the present invention is not limited to these descriptions, and it will be obvious to those skilled in the art that various modifications and improvements are possible.

For example, in the above-described embodiment, the names parent node, IAB node, and child node are used, but the names may be different as long as a radio communication node configuration is employed in which radio backhaul between radio communication nodes such as gNBs and radio access with a terminal are integrated. For example, these may be simply referred to as a first or second node, or these may be referred to as an upper node and a lower node, or a relay node and an intermediate node.

In addition, the radio communication node may also be simply referred to as a communication device or a communication node, or may be replaced with a radio base station.

In the above-described embodiment, the terms downlink (DL) and uplink (UL) are used; however, different terms may be used. For example, the above terms may be replaced or associated with terms such as a forward ring, a reverse link, an access link, and backhaul. Alternatively, terms such as a first link, a second link, a first direction, and a second direction may simply be used.

In the above-described embodiment, Case #1, Case #6, and Case #7 were mainly described as a method for aligning an MT transmission timing. However, in the embodiment, the method for aligning an MT transmission timing may include a method other than Case #1, Case #6, and Case #7 (for example, Case #3, Case #4, Case #5, or the like).

The block diagram (FIGS. 3, 4) used in the description of the above-described embodiment shows blocks in units of functions. Those functional blocks (components) can be realized by a desired combination of at least one of hardware and software. A realization method for each functional block is not particularly limited. That is, each functional block may be realized by using one device combined physically or logically. Alternatively, two or more devices separated physically or logically may be directly or indirectly connected (for example, wired, or wireless) to each other, and each functional block may be realized by these plural devices. The functional blocks may be realized by combining software with the one device or the plural devices mentioned above.

Functions include judging, deciding, determining, calculating, computing, processing, deriving, investigating, searching, confirming, receiving, transmitting, outputting, accessing, resolving, selecting, choosing, establishing, comparing, assuming, expecting, considering, broadcasting, notifying, communicating, forwarding, configuring, reconfiguring, allocating (mapping), assigning, and the like. However, the functions are not limited thereto. For example, a functional block (component) that makes a transmitting function work may be called a transmitting unit or a transmitter. For any of the above, as described above, the realization method is not particularly limited.

Further, the above-described CU 50 and radio communication nodes 100A to 100C (the device) may function as a computer that performs processing of a radio communication method of the present disclosure. FIG. 13 is a diagram showing an example of a hardware configuration of the device. As shown in FIG. 13, the device may be configured as a computer device including a processor 1001, a memory 1002, a storage 1003, a communication device 1004, an input device 1005, an output device 1006, a bus 1007, and the like.

Furthermore, in the following description, the term “device” can be substituted with circuit, device, unit, or the like. The hardware configuration of the device may include one or more devices shown in the figure or may not include some of the devices.

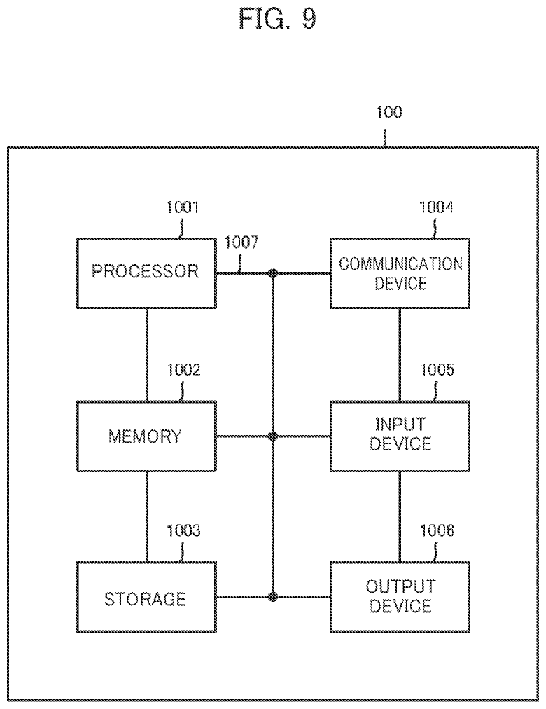

Each of the functional blocks of the device (see FIGS. 3, 4) is implemented by means of any of hardware elements of the computer device or a combination of the hardware elements. FIG. 9 is a diagram showing an example of a hardware configuration of CU 50 and radio communication nodes 100A to 100C.

Each function in the device is realized by loading predetermined software (programs) on hardware such as the processor 1001 and the memory 1002 so that the processor 1001 performs arithmetic operations to control communication via the communication device 1004 and to control at least one of reading and writing of data on the memory 1002 and the storage 1003.

The processor 1001 operates, for example, an operating system to control the entire computer. The processor 1001 may be configured with a Central Processing Unit (CPU) including interfaces with peripheral devices, control devices, arithmetic devices, registers, and the like.

Moreover, the processor 1001 reads a program (program code), a software module, data, and the like from at least one of the storage 1003 and the communication device 1004 into the memory 1002, and executes various processes according to these. As the program, a program causing the computer to execute at least part of the operation described in the above embodiment is used. Alternatively, various processes described above can be executed by one processor 1001 or can be executed simultaneously or sequentially by two or more processors 1001. The processor 1001 can be implemented by using one or more chips. Alternatively, the program may be transmitted from a network via a telecommunication line.

The memory 1002 is a computer readable recording medium and may be configured, for example, with at least one of a Read Only Memory (ROM), Erasable Programmable ROM (EPROM), Electrically Erasable Programmable ROM (EEPROM), Random Access Memory (RAM), and the like. The memory 1002 may be referred to as a register, cache, main memory (main storage device), and the like. The memory 1002 may store therein programs (program codes), software modules, and the like that can execute the method according to one embodiment of the present disclosure.

The storage 1003 is a computer readable recording medium. Examples of the storage 1003 include at least one of an optical disk such as Compact Disc ROM (CD-ROM), a hard disk drive, a flexible disk, a magneto-optical disk (for example, a compact disk, a digital versatile disk, Blu-ray (registered trademark) disk), a smart card, a flash memory (for example, a card, a stick, a key drive), a floppy (registered trademark) disk, a magnetic strip, and the like. The storage 1003 can be referred to as an auxiliary storage device. The recording medium can be, for example, a database including at least one of the memory 1002 and the storage 1003, a server, or other appropriate medium.

The communication device 1004 is hardware (transmission/reception device) capable of performing communication between computers via at least one of a wired network and a wireless network. The communication device 1004 is also referred to as, for example, a network device, a network controller, a network card, a communication module, and the like.

The communication device 1004 may include a high-frequency switch, a duplexer, a filter, a frequency synthesizer, and the like in order to realize, for example, at least one of Frequency Division Duplex (FDD) and Time Division Duplex (TDD).

The input device 1005 is an input device (for example, a keyboard, a mouse, a microphone, a switch, a button, a sensor, and the like) that accepts input from the outside. The output device 1006 is an output device (for example, a display, a speaker, an LED lamp, and the like) that outputs data to the outside. Note that, the input device 1005 and the output device 1006 may have an integrated configuration (for example, a touch screen).

Also, the respective devices such as the processor 1001 and the memory 1002 are connected to each other with the bus 1007 for communicating information. The bus 1007 may be constituted by a single bus or may be constituted by different buses for each device-to-device.

Further, the device may be configured to include hardware such as a microprocessor, a Digital Signal Processor (DSP), an Application Specific Integrated Circuit (ASIC), a Programmable Logic Device (PLD), and a Field Programmable Gate Array (FPGA). Some or all of these functional blocks may be realized by means of this hardware. For example, the processor 1001 may be implemented by using at least one of the above-described items of hardware.

Further, notification of information is not limited to that in the aspect/embodiment described in the present disclosure, and may be performed by using other methods. For example, notification of information may be performed by physical layer signaling (for example, Downlink Control Information (DCI), Uplink Control Information (UCI)), higher layer signaling (for example, RRC signaling, Medium Access Control (MAC) signaling), broadcast information (Master Information Block (MIB), System Information Block (SIB)), other signals, or a combination thereof. The RRC signaling may also be referred to as an RRC message, for example, or may be an RRC Connection Setup message, an RRC Connection Reconfiguration message, or the like.

Each aspect/embodiment described in the present disclosure can be applied to at least one of Long Term Evolution (LTE), LTE-Advanced (LTE-A), SUPER 3G, IMT-Advanced, the 4th generation mobile communication system (4G), the 5th generation mobile communication system (5G), Future Radio Access (FRA), New Radio (NR), W-CDMA (registered trademark), GSM (registered trademark), CDMA2000, Ultra Mobile Broadband (UMB), IEEE 802.11 (Wi-Fi (registered trademark)), IEEE 802.16 (WiMAX (registered trademark)), IEEE 802.20, ultra-wideband (UWB), Bluetooth (registered trademark), a system using any other appropriate system, and a next-generation system that is expanded based on these. Further, a plurality of systems may be combined (for example, a combination of at least one of LTE and LTE-A with 5G) and applied.

The order of the processing procedures, sequences, flowcharts, and the like of each aspect/embodiment described in the present disclosure may be exchanged as long as there is no contradiction. For example, the methods described in the present disclosure present the elements of the various steps by using an exemplary order and are not limited to the presented specific order.

The specific operation that is performed by a base station in the present disclosure may be performed by its upper node in some cases. In a network constituted by one or more network nodes having a base station, it is obvious that the various operations performed for communication with the terminal may be performed by at least one of the base station and other network nodes other than the base station (for example, an MME, an S-GW, and the like may be considered, but there is not limited thereto). In the above, an example in which there is one network node other than the base station is explained; however, a combination of a plurality of other network nodes (for example, an MME and an S-GW) may be used.

Information and signals (information and the like) can be output from a higher layer (or lower layer) to a lower layer (or higher layer). These may be input and output via a plurality of network nodes.

The input/output information can be stored in a specific location (for example, a memory) or can be managed in a management table. The information to be input/output can be overwritten, updated, or added. The information can be deleted after outputting. The inputted information can be transmitted to another device.

The determination may be made by using a value (0 or 1) represented by one bit, by truth-value (Boolean: true or false), or by comparison of numerical values (for example, comparison with a predetermined value).

Each of the aspects/embodiment described in the present disclosure may be used separately or in combination, or may be switched in accordance with the execution. In addition, notification of predetermined information (for example, notification of “is X”) is not limited to being performed explicitly, and it may be performed implicitly (for example, without notifying the predetermined information).

Regardless of being referred to as software, firmware, middleware, microcode, hardware description language, or some other name, software should be interpreted broadly to mean instructions, an instruction set, code, a code segment, program code, a program, a subprogram, a software module, an application, a software application, a software package, a routine, a subroutine, an object, an executable file, an execution thread, a procedure, a function, and the like.

Further, software, instruction, information, and the like may be transmitted and received via a transmission medium. For example, when software is transmitted from a website, a server, or another remote source by using at least one of a wired technology (a coaxial cable, an optical fiber cable, a twisted pair cable, a Digital Subscriber Line (DSL), or the like) and a wireless technology (infrared light, microwave, or the like), then at least one of these wired and wireless technologies is included within the definition of the transmission medium.

Information, signals, or the like described in the present invention may be represented by using any of a variety of different technologies. For example, data, an instruction, a command, information, a signal, a bit, a symbol, a chip, or the like that may be mentioned throughout the above description may be represented by a voltage, a current, an electromagnetic wave, a magnetic field or magnetic particles, an optical field or photons, or a desired combination thereof.

It should be noted that the terms described in the present disclosure and terms necessary for understanding the present disclosure may be replaced with terms having the same or similar meanings. For example, at least one of a channel and a symbol may be a signal (signaling). A signal may also be a message. Further, a Component Carrier (CC) may be referred to as a carrier frequency, a cell, a frequency carrier, or the like.

The terms “system” and “network” used in the present disclosure can be used interchangeably.

Furthermore, information, parameters, and the like described in the present disclosure can be represented by an absolute value, can be represented by a relative value from a predetermined value, or can be represented by corresponding other information. For example, a radio resource can be indicated using an index.

Names used for the above parameters are not restrictive names in any respect. In addition, formulas and the like using these parameters may be different from those explicitly disclosed in the present disclosure. Since the various channels (for example, a PUCCH, a PDCCH, or the like) and information elements can be identified by any suitable names, the various names allocated to these various channels and information elements shall not be restricted in any way.

In the present disclosure, the terms such as “base station (Base Station: BS)”, “radio base station”, “fixed station”, “NodeB”, “eNodeB (eNB)”, “gNodeB (gNB)”, “access point”, “transmission point”, “reception point”, “transmission/reception point”, “cell”, “sector”, “cell group”, “carrier”, “component carrier”, and the like can be used interchangeably. A base station may also be referred to with a term such as a macro cell, a small cell, a femtocell, or a pico cell.

A base station can accommodate one or more (for example, three) cells (also referred to as sectors). In a configuration in which a base station accommodates a plurality of cells, the entire coverage area of the base station can be divided into a plurality of smaller areas. In each of the smaller areas, a communication service can be provided by a base station subsystem (for example, a small base station for indoor use (remote radio head: RRH)).

The term “cell” or “sector” refers to a part or all of the coverage area of at least one of a base station and a base station subsystem that performs a communication service in this coverage.

In the present disclosure, the terms such as “mobile station (Mobile Station: MS)”, “user terminal”, “user equipment (User Equipment: UE)”, and “terminal” can be used interchangeably.

A mobile station may be referred to as a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable terms by those skilled in the art.

At least one of a base station and a mobile station may be called a transmitting device, a receiving device, a communication device, or the like. Note that at least one of a base station and a mobile station may be a device mounted on a moving body, a moving body itself, or the like. The moving body may be a vehicle (for example, a car, an airplane, or the like), an unmanned moving body (a drone, a self-driving car, or the like), or a robot (manned type or unmanned type). At least one of a base station and a mobile station also includes a device that does not necessarily move during the communication operation. For example, at least one of a base station and a mobile station may be an Internet of Things (IoT) device such as a sensor.

Also, a base station in the present disclosure may be substituted with a mobile station (user terminal, hereinafter the same). For example, each aspect/embodiment of the present disclosure may be applied to a configuration in which communication between a base station and a mobile station is replaced with communication between a plurality of mobile stations (for example, this may be called Device-to-Device (D2D), Vehicle-to-Everything (V2X), or the like). In this case, the mobile station may have the function of a base station. In addition, words such as “uplink” and “downlink” may also be substituted with words corresponding to inter-terminal communication (for example, “side”). For example, an uplink channel, a downlink channel, or the like may be substituted with a side channel.

Similarly, the mobile station in the present disclosure may be read as a base station. In this case, the base station may have the function of the mobile station.

A radio frame may be composed of one or more frames in the time domain. Each of the one or more frames in the time domain may be referred to as a subframe.

A subframe may be further composed of one or more slots in the time domain. The subframe may be a fixed time length (for example, 1 ms) independent of the numerology.

The numerology may be a communication parameter applied to at least one of transmission and reception of a certain signal or channel. The numerology may indicate at least one of, for example, subcarrier spacing (SCS), bandwidth, symbol length, cyclic prefix length, transmission time interval (TTI), the number of symbols per TTI, radio frame configuration, a specific filtering process performed by a transceiver in the frequency domain, a specific windowing process performed by a transceiver in the time domain, and the like.

A slot may be composed of one or more symbols (Orthogonal Frequency Division Multiplexing (OFDM)) symbols, Single Carrier Frequency Division Multiple Access (SC-FDMA) symbols, and the like) in the time domain. A slot may be a unit of time based on the numerology.

A slot may include a plurality of minislots. Each minislot may be composed of one or more symbols in the time domain. A minislot may be called a subslot. A minislot may be composed of fewer symbols than slots. A PDSCH (or PUSCH) transmitted in time units greater than the minislot may be referred to as a PDSCH (or PUSCH) mapping type A. A PDSCH (or PUSCH) transmitted using a minislot may be referred to as a PDSCH (or PUSCH) mapping type B.

Each of a radio frame, subframe, slot, minislot, and symbol represents a time unit for transmitting a signal. A radio frame, subframe, slot, minislot, and symbol may have respectively different names corresponding to them.

For example, one subframe may be called a transmission time interval (TTI), a plurality of consecutive subframes may be called a TTI, and one slot or one minislot may be called a TTI. That is, at least one of the subframe and TTI may be a subframe (1 ms) in the existing LTE, a period shorter than 1 ms (for example, 1-13 symbols), or a period longer than 1 ms. Note that, a unit representing TTI may be called a slot, a minislot, or the like instead of a subframe.

Here, a TTI refers to the minimum time unit of scheduling in radio communication, for example. For example, in the LTE system, the base station performs scheduling for allocating radio resources (frequency bandwidth, transmission power, and the like that can be used in each user terminal) to each user terminal in units of TTI. The definition of TTI is not limited to this.

A TTI may be a transmission time unit such as a channel-encoded data packet (transport block), a code block, or a code word, or may be a processing unit such as scheduling or link adaptation. When a TTI is given, a time interval (for example, the number of symbols) in which a transport block, a code block, a code word, and the like are actually mapped may be shorter than TTI.

When one slot or one minislot is called a TTI, one or more TTIs (that is, one or more slots or one or more minislots) may be the minimum time unit of the scheduling. The number of slots (minislot number) constituting the minimum time unit of the scheduling may be controlled.

A TTI having a time length of 1 ms may be referred to as an ordinary TTI (TTI in LTE Rel. 8-12), a normal TTI, a long TTI, an ordinary subframe, a normal subframe, a long subframe, a slot, and the like. A TTI shorter than the ordinary TTI may be referred to as a shortened TTI, a short TTI, a partial TTI (partial or fractional TTI), a shortened subframe, a short subframe, a minislot, a subslot, a slot, and the like.

In addition, a long TTI (for example, ordinary TTI, subframe, and the like) may be read as a TTI having a time length exceeding 1 ms, and a short TTI (for example, shortened TTI) may be read as a TTI having a TTI length of less than a TTI length of a long TTI and a TTI length of 1 ms or more.

A resource block (RB) is a resource allocation unit in the time domain and the frequency domain, and may include one or more consecutive subcarriers in the frequency domain. The number of subcarriers included in the RB may be the same regardless of the numerology, and may be 12, for example. The number of subcarriers included in the RB may be determined based on the numerology.

Further, the time domain of an RB may include one or more symbols, and may have a length of 1 slot, 1 minislot, 1 subframe, or 1 TTI. Each TTI, subframe, or the like may be composed of one or more resource blocks.

Note that, one or more RBs may be called a physical resource block (PRB), a sub-carrier group (SCG), a resource element group (REG), a PRB pair, a RB pair, and the like.

A resource block may be configured by one or more resource elements (REs). For example, one RE may be a radio resource domain of one subcarrier and one symbol.

A bandwidth part (BWP) (which may be called a partial bandwidth or the like) may represent a subset of consecutive common resource blocks (RBs) for a certain numerology in a certain carrier. Here, the common RB may be specified by an index of the RB based on the common reference point of the carrier. A PRB may be defined in a certain BWP and numbered within that BWP.

A BWP may include a BWP for UL (UL BWP) and a BWP for DL (DL BWP). One or more BWPs may be set in one carrier for the UE.

At least one of the configured BWPs may be active, and the UE does not have to expect to transmit and receive predetermined signals/channels outside the active BWP. Note that “cell”, “carrier”, and the like in this disclosure may be read as “BWP”.

The above-described structures such as a radio frame, a subframe, a slot, a minislot, and a symbol are merely examples. For example, structures such as the number of subframes included in a radio frame, the number of slots per subframe or radio frame, the number of minislots included in a slot, the number of symbols and RBs included in a slot or minislot, the number of subcarriers included in RBs, and the number of symbols included in a TTI, a symbol length, the cyclic prefix (CP) length, and the like can be changed in various manner.

The terms “connected”, “coupled”, or any variations thereof mean any direct or indirect connection or coupling between two or more elements, and can include that one or more intermediate elements are present between two elements that are “connected” or “coupled” to each other. The coupling or connection between the elements may be physical, logical, or a combination thereof. For example, “connection” may be substituted with “access”. In the present disclosure, two elements can be “connected” or “coupled” to each other by using at least one of one or more wires, one or more cables, and one or more printed electrical connections, and as some non-limiting and non-exhaustive examples, by using electromagnetic energy having wavelengths in the radio frequency domain, a microwave region, and a light (both visible and invisible) region, and the like.

A reference signal may be abbreviated as RS and may be called a pilot according to applicable standards.

As used in the present disclosure, the phrase “based on” does not mean “based only on” unless explicitly stated otherwise. In other words, the phrase “based on” means both “based only on” and “based at least on”.

“Means” in the configuration of each device above may be replaced with “unit”, “circuit”, “device”, and the like.

Any reference to elements using a designation such as “first”, “second”, or the like used in the present disclosure generally does not limit the amount or order of those elements. Such designations can be used in the present disclosure as a convenient method to distinguish between two or more elements. Thus, the reference to the first and second elements does not imply that only two elements can be adopted, or that the first element must precede the second element in some or the other manner.

In the present disclosure, the used terms “include”, “including”, and variants thereof are intended to be inclusive in a manner similar to the term “comprising”. Furthermore, the term “or” used in the present disclosure is intended not to be an exclusive-OR.

Throughout the present disclosure, for example, during translation, if articles such as a, an, and the in English are added, the present disclosure may include that a noun following these articles is used in plural.

As used in this disclosure, the term “determining” may encompass a wide variety of actions. “determining” includes deeming that determining has been performed by, for example, judging, calculating, computing, processing, deriving, investigating, searching (looking up, search, inquiry) (for example, searching in a table, database, or another data structure), ascertaining, and the like. In addition, “determining” can include deeming that determining has been performed by receiving (for example, receiving information), transmitting (for example, transmitting information), inputting (input), outputting (output), access (accessing) (for example, accessing data in a memory), and the like. In addition, “determining” can include deeming that determining has been performed by resolving, selecting, choosing, establishing, comparing, and the like. That is, “determining” may include deeming that “determining” regarding some action has been performed. Moreover, “determining” may be read as “assuming”, “expecting”, “considering”, and the like.

In the present disclosure, the wording “A and B are different” may mean “A and B are different from each other”. It should be noted that the wording may mean “A and B are each different from C”. Terms such as “separate”, “couple”, or the like may also be interpreted in the same manner as “different”.

Although the present disclosure has been described in detail above, it will be obvious to those skilled in the art that the present disclosure is not limited to the embodiments described in the present disclosure. The present disclosure can be implemented as modifications and variations without departing from the spirit and scope of the present disclosure as defined by the claims. Therefore, the description of the present disclosure is for the purpose of illustration, and does not have any restrictive meaning to the present disclosure.

### REFERENCE SIGNS LIST

10 radio communication system
50 CU
100A, 100B, 100C radio communication node
110 radio transmission unit
120 radio reception unit
130 NW IF unit
140 control unit
150 timing-related information transmission unit
161 radio transmission unit
162 radio reception unit
165 timing-related information transmission unit
170 control unit
200 UE
1001 processor
1002 memory
1003 storage
1004 communication device
1005 input device
1006 output device
1007 bus

1. A radio communication node, comprising:
a control unit that determines a downlink transmission timing in the radio communication node based on a downlink transmission timing in an upper node; and
a transmission/reception unit that performs transmission and reception at the determined timing, wherein
the control unit determines an uplink transmission timing in the radio communication node based on a specifying method.

2. The radio communication node according to claim 1, wherein
the specifying method includes a method for configuring the uplink transmission timing in the radio communication node by means of the upper node.

3. The radio communication node according to claim 1, wherein
the specifying method includes a method for specifying the uplink transmission timing in the radio communication node by means of the radio communication node.

4. The radio communication node according to claim 1, wherein
the specifying method includes a method for determining the uplink transmission timing in the radio communication node based on a predetermined rule.

5. A radio communication method comprising:
a step of determining a downlink transmission timing in a radio communication node based on a downlink transmission timing in an upper node;
a step of determining an uplink transmission timing in the radio communication node based on a specifying method; and
a step of performing transmission and reception at the determined timing.
